(19) United States
(12) Patent Application Publication
(10) Pub. No.: US 2015/0281002 A1
(43) Pub. Date: Oct. 1, 2015

(54) UNIVERSAL SUPPORT SYSTEM FOR INTERNET OF THINGS

(71) Applicant: TSINGHUA UNIVERSITY, Beijing (CN)

(72) Inventors: Ke Xu, Beijing (CN); Xin Liu, Beijing (CN); Yuchao Zhang, Beijing (CN); Wenlong Chen, Beijing (CN); Yaxiao Liu, Beijing (CN)

(21) Appl. No.: 14/430,894

(22) PCT Filed: Dec. 30, 2013
(86) PCT No.: PCT/CN2013/090931

§ 371 Date: Mar. 24, 2015

(30) Foreign Application Priority Data
Sep. 9, 2013 (CN) 201310407416.0

(51) Int. Cl. H04L 12/24

(52) U.S. Cl. CPC H04L 41/50; H04L 41/24

(57) ABSTRACT

A universal support system for Internet of Things is provided. The system comprises: a user program management center, configured to send a request for an existing program or a request for a customized program according to an instruction input by a user; a management and control center, configured to obtain an existing program according to the request for the existing program, to generate a customized program according to the request for the customized program, to deploy the existing program, and to deploy the customized program according to the description of resource requirements and description of functional requirements of the customized program; and a sensor network, configured to run the existing program or the customized program according to the deployment, to obtain operation data during running an existing program or a customized program, and to send the operation data to the user program management center via the management and control center.

### CROSS-REFERENCE TO RELATED APPLICATION

This application claims priority to and benefits of Chinese Patent Application Serial No. 201310407416.0, filed with the State Intellectual Property Office of P. R. China on Sep. 9, 2013, the entire content of which is incorporated herein by reference.

### FIELD

Embodiments of the present disclosure generally relate to technology communication technology field, and more particularly to a universal support system for Internet of Things.

### BACKGROUND

The Internet of Things is a network that collects real-time information from any intelligent device by a variety of sensors. With the rapid development of the intelligent devices, the Internet of Things has been used more and more widely.

Each operator desires to establish a management platform for his own Internet of Things. However, with the increment of business types and the expansion of services, it is more difficult for the operator to establish infrastructures and satisfy service requirements. Moreover, it is difficult for operators to cooperate with each other due to a lot of problems such as a variety of intelligent devices, considerable differences among network structures and a difficulty in unifying heterogeneous network protocols. These problems greatly limit the development of the Internet of Things.

### SUMMARY

Embodiments of the present disclosure seek to solve at least one of the problems existing in the prior art to at least some extent.

One objective of the present disclosure is to provide a universal support system for Internet of Things.

According to embodiments of the present disclosure, a universal support system for Internet of Things is provided. The system comprises: a user program management center, configured to send a request for an existing program or a request for a customized program according to an instruction input by a user, and requests for customized programs comprise description of resource requirements and description of functional requirements; a management and control center, connected with the user program management center, and configured to obtain an existing program according to the request for the existing program, to generate a customized program according to the request for the customized program, to deploy the existing program, and to deploy the customized program according to the description of resource requirements and description of functional requirements of the customized program; and a sensor network, connected with the management and control center, and configured to run the existing program or the customized program according to a deployment of the management and control center, to obtain operation data of the Internet of Things generated during running the existing program or the customized program, and to send the operation data to the management and control center, in which the management and control center receives the operation data and transfers the operation data to the user program management center for display.

In one embodiment of the present disclosure, the user program management center comprises: a user interface, configured to receive a program identification, the description of resource requirements and the description of functional requirements input by users, to generate the request for the existing program according to the program identification, and to generate the request for the customized program according to the description of resource requirements and the description of functional requirements; a program requesting module, configured to send the request for the existing program to the management and control center; and a checking module, configured to perform a validity check, a reserved resource check and a confliction check according to pre-stored information of the sensor network, the description of resource requirements and the description of functional requirements, and to send the request for the customized program to the management and control center when the request for the customized program passes the validity check, the reserved resource check and the confliction check.

In one embodiment of the present disclosure, the management and control center comprises: an authorization managing module, configured to receive the request for the existing program, and to authorize the request for the existing program according to preset rules; a language analyzing module, configured to receive the request for the customized program, and to generate the customized program by analyzing the request for the customized program according to preset semantic and grammar rules; a program deploying module, configured to deploy the existing program and the customized program according to the information of the sensor network, the description of resources requirements and description of functional requirements; a data analyzing module, configured to receive the operation data of the Internet of Things sent by the sensor network, and to obtain operation results by analyzing the operation data of the Internet of Things; a control module, connected with the authorization managing module, the language analyzing module, the program deploying module and the data analyzing module respectively, and configured to obtain the existing program when the request for the existing program is authorized by the authorization managing module, to write the customized program into a program database, to send the existing program and the customized program to the program deploying module, to receive the operation results sent by the data analyzing module, and to update or modify the existing program or the customized program according to the operation results; and the program database, connected with the control module, and configured to store the existing programs, and to receive and store the customized program sent by the control module.

In one embodiment of the present disclosure, the authorization managing module is further configured to authorize the request for the existing program when the user inputting the request for the existing program is a paying user.

In one embodiment of the present disclosure, the sensor network comprises: a plurality of sensor nodes, configured to run the existing program or the customized program according to the deployment of the management and control center, and to obtain the operation data generated during running the existing program or the customized program; a cloud resource server, connected with the plurality of sensor nodes via gateways, and configured to store the information of the sensor network, to receive the existing program or the customized program, to send the existing program or the customized program to corresponding ones of the plurality of sensor nodes according to the deployment of the management and control center, to receive the operation data sent by the corresponding ones of the plurality of sensor nodes, and to send the operation data to the management and control center; and the gateway, configured to connect the plurality of sensor nodes with the cloud resource server.

In one embodiment of the present disclosure, the cloud resource server is further configured to send the information of the sensor network to the control module so as to update the information of the sensor network.

In one embodiment of the present disclosure, the data analyzing module is further configured to select parameters of the operation data according to the description of functional requirements, and to obtain the operation results by analyzing the selected parameters.

In one embodiment of the present disclosure, the checking module comprises: a validity checking unit, configured to check whether the request for the customized program is valid; a reserved resource checking unit, configured to check whether there are sensor nodes satisfying the resource requirements of the customized program according to the information of the sensor network and the description of resource requirements; and a confliction checking unit, configured to check whether there is a confliction between the customized program and the existing programs stored in the program database according to the description of functional requirements.

In one embodiment of the present disclosure, the system further comprised: an evaluating module, connected between the sensor network and the management and control center, and configured to collect the operation data of the Internet of Things, to determine whether the operation data is valid, and to send the operation data to the data analyzing module when the operation data is invalid.

In one embodiment of the present disclosure, the information of the sensor network comprises a name, a type and an operation mode of each sensor node in the sensor network.

The system according to embodiments of the present disclosure provides a universal platform for different operators, which unifies the Internet of Things effectively, thus facilitating expanding services of operators and providing a good environment for the Internet of Things.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a block diagram of a universal support system for Internet of Things according to an embodiment of the present disclosure;

FIG. 2 is a block diagram of a user program management center according to an embodiment of the present disclosure;

FIG. 3 is a block diagram of a checking module according to an embodiment of the present disclosure;

FIG. 4 is block diagram of a management and control center according to an embodiment of the present disclosure;

FIG. 5 is block diagram of a sensor network according to an embodiment of the present disclosure;

FIG. 6 is a block diagram of a universal support system for Internet of Things according to another embodiment of the present disclosure; and

FIG. 7 is a block diagram of a universal support system for Internet of Things according to yet another embodiment of the present disclosure;

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

It is to be understood that, in the description of the present disclosure, terms of “first” and “second” are only used for description and cannot be seen as indicating or implying relative importance. Unless otherwise stipulated and restricted, it is to be explained that terms of “linkage” and “connection” shall be understood broadly, for example, it could be mechanical connection or electrical connection; it could be direct linkage, indirect linkage via intermediate medium. Those skilled in the art shall understand the concrete notations of the terms mentioned above according to specific circumstances. Furthermore, unless otherwise explained, it is to be understood that a term of “a plurality of ” refers to two or more.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions. These and other aspects should be understood by those skilled in the art with reference to the following description and drawings. In these description and drawings, some particular implementations of the present disclosure are disclosed to present some ways for implementing the principle of the present disclosure. However, it should be understood that embodiments of the present disclosure is not limited to this. Contrarily, embodiments of the present disclosure include all the variations, modifications and equivalents within the spirit and scope of the appended claims.

In the following, a system for supporting an Internet of Things according to embodiments of the present disclosure will be described in detail with reference to drawings.

FIG. 1 is a block diagram of a system for supporting an Internet of Things according to an embodiment of the present disclosure. As shown in FIG. 1, the system comprises a user program management center 100, a management and control center 200 and a sensor network 300.

The user program management center 100 is configured to send a request for an existing program or a request for a customized program according to an instruction input by a user. The request for the customized program comprises description of resource requirements and description of functional requirements. The management and control center 200 is connected with the user program management center 100, and configured to obtain an existing program according to the request for the existing program, to generate a customized program according to the request for the customized program, and to deploy the existing program or the customized program according to the description of resource requirements and description of functional requirements of the existing program or the customized program. The sensor network 300 is connected with the management and control center 200, and configured to run the existing program or the customized program according to a deployment of the management and control center 200, to obtain operation data of the Internet of Things generated during running the existing program or the customized program, and to send the operation data to the management and control center. The management and control center 200 is further configured to receive the operation data and transfer the operation data to the user program management center 200 for display.

In one embodiment of the present disclosure, when a user logins to the user program management center 100, he can check whether a desired program is stored in the system for supporting an Internet of Things, and if yes, the user selects to apply for the existing program, and if no, the user applies for customizing the desired program.

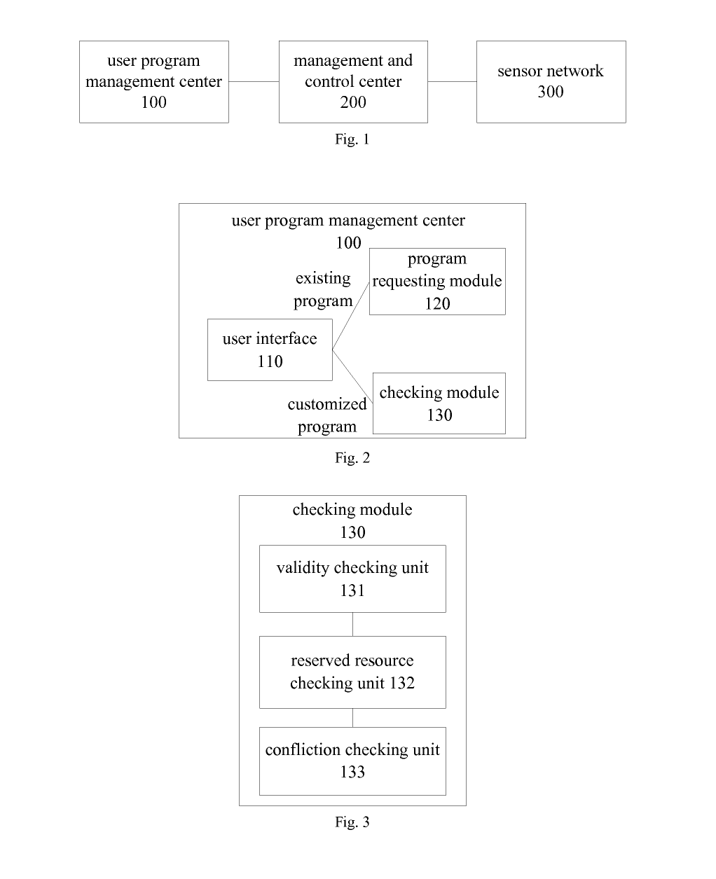

In one embodiment of the present disclosure, as shown in FIG. 2, the user program management center 100 comprises a user interface 110, a program requesting module 120 and a checking module 130.

More specifically, the user interface 110 is configured to receive a program identification, the description of resource requirements and the description of functional requirements input by the user, to generate the request for the existing program according to the program identification, and to generate the request for the customized program according to the description of resource requirements and the description of functional requirements.

In one embodiment of the present disclosure, the user interface 110 is configured to provide preset program format standard, so as to make sure that the description of resource requirements and the description of functional requirements input by the user satisfy the programming language rules of the system for supporting an Internet of Things.

The program requesting module 120 is configured to send the request for the existing program to the management and control center 200.

The checking module 130 is configured to perform a validity check, a reserved resource check and a confliction check according to pre-stored information of the sensor network, the description of resource requirements and the description of functional requirements, and to send the request for the customized program to the management and control center 200 when the request for the customized program passes the validity check, the reserved resource check and the confliction check.

In one embodiment of the present disclosure, as shown in FIG. 3, the checking module 130 comprises a validity checking unit 131, a reserved resource checking unit 132 and a confliction checking unit 133.

The validity checking unit 131 is configured to check whether the request for the customized program is valid, and if no, discard the request for the customized program, and if yes, go on using the request for the customized program.

The reserved resource checking unit 132 is configured to check whether there are sensor nodes satisfying the resource requirements of the customized program according to the information of the sensor network and the description of resource requirements. In one embodiment of the present disclosure, the reserved resource checking unit 132 is further configured to reserve cloud resource, gateway and sensor nodes for the customized program.

The confliction checking unit 133 is configured to check whether there is a confliction between the customized program and the existing programs stored in the program database according to the description of functional requirements, and if yes, discards the request for the customized program, and if no, sends the request for the customized program to the management and control center 200.

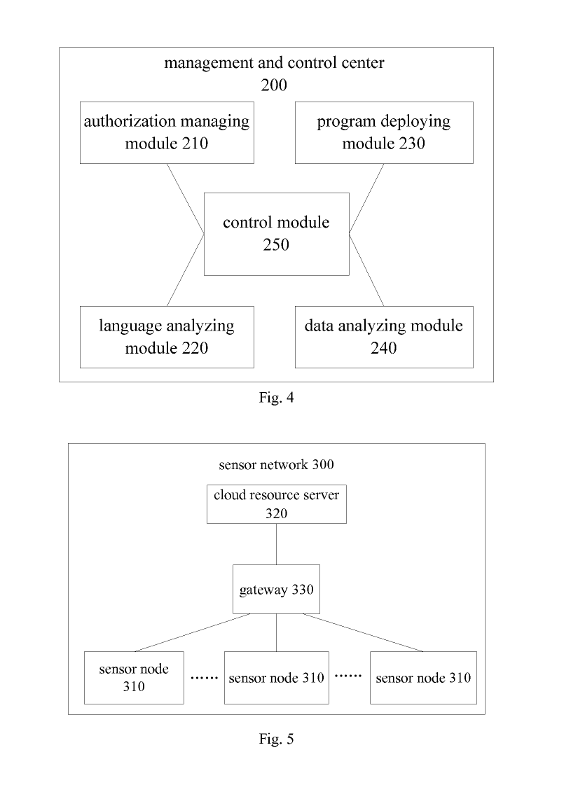

In one embodiment of the present disclosure, as shown in FIG. 4, the management and control center 200 comprises an authorization managing module 210, a language analyzing module 220, a program deploying module 230, a data analyzing module 240 and a control module 250.

More specifically, the authorization managing module 210 is configured to receive the request for the existing program, and to authorize the request for the existing program according to preset rules. In one embodiment of the present disclosure, the authorization managing module 210 authorizes the request for the existing program when the user inputting the request for the existing program is a paying user, and does not authorize the request for the existing program when the user is not a paying user.

The language analyzing module 220 is configured to receive the request for the customized program, and to obtain the customized program by analyzing the request for the customized program according to preset semantic and grammar rules. In one embodiment of the present disclosure, the language analyzing module 220 is specifically configured to obtain the description of resource requirements and the description of functional requirements according to preset semantic and grammar rules, to generate the customized program according to the description of resource requirements and the description of functional requirements, and to send the customized program to the control module 250.

The program deploying module 230 is configured to deploy the existing program and the customized program according to the information of the sensor network, the description of resources requirements and description of functional requirements.

The data analyzing module 240 is configured to receive the operation data of the Internet of Things sent by the sensor network, and to obtain operation results by analyzing the operation data of the Internet of Things. In some embodiments of the present disclosure, the data analyzing module 240 may be configured to select parameters of the operation data according to the description of functional requirements and to obtain the operation results by analyzing the selected parameters. In other embodiments of the present disclosure, the data analyzing module 240 may also be further configured to analyze the operation results, such that the program can be repaired using software when the program is needed to be repaired.

The control module 250 is connected with the authorization managing module 210, the language analyzing module 220, the program deploying module 230 and the data analyzing module 240 respectively. The control module 250 is configured to obtain the existing program when the request for the existing program is authorized by the authorization managing module, to send the existing program and the customized program to the program deploying module, to receive the operation results sent by the data analyzing module, and to update or modify the existing program or the customized program according to the operation results.

In one embodiment of the present disclosure, as shown in FIG. 5, the sensor network 300 comprises a plurality of sensor nodes 310, a cloud resource server 320 and a gateway 330.

More specifically, the plurality of sensor nodes 310 is configured to run the existing program or the customized program according to the deployment of the management and control center 200, and to obtain the operation data of the Internet of Things generated during running the existing program or the customized program;

The cloud resource server 320 is connected with the plurality of sensor nodes 310 via the gateway 330. The cloud resource server 320 is configured to store the information of the sensor network 300, to receive the existing program or the customized program, to send the existing program or the customized program to corresponding ones of the plurality of sensor nodes 310 according to the deployment of the management and control center 200, to receive the operation data of the Internet of Things sent by the corresponding ones of the plurality of sensor nodes 310, to send the operation data of the Internet of Things to the management and control center 200. In one embodiment, the information of the sensor network 300 comprises a name, a type and an operation mode of each sensor node 310 in the sensor network.

In one embodiment of the present disclosure, the cloud resource server 320 may be further configured to send the information of the sensor network 300 to the control module 250 so as to update the information of the sensor network 300. Specifically, the cloud resource server 320 sends the information of the sensor network 300 to the control module 250, and then the control module 300 updates the information of the sensor network 300 and sends the updated information of the sensor network 300 to the checking module 130.

The gateway 330 is configured to connect the plurality of sensor nodes 310 with the cloud resource server 320, and to transfer the internal communication data of the sensor network.

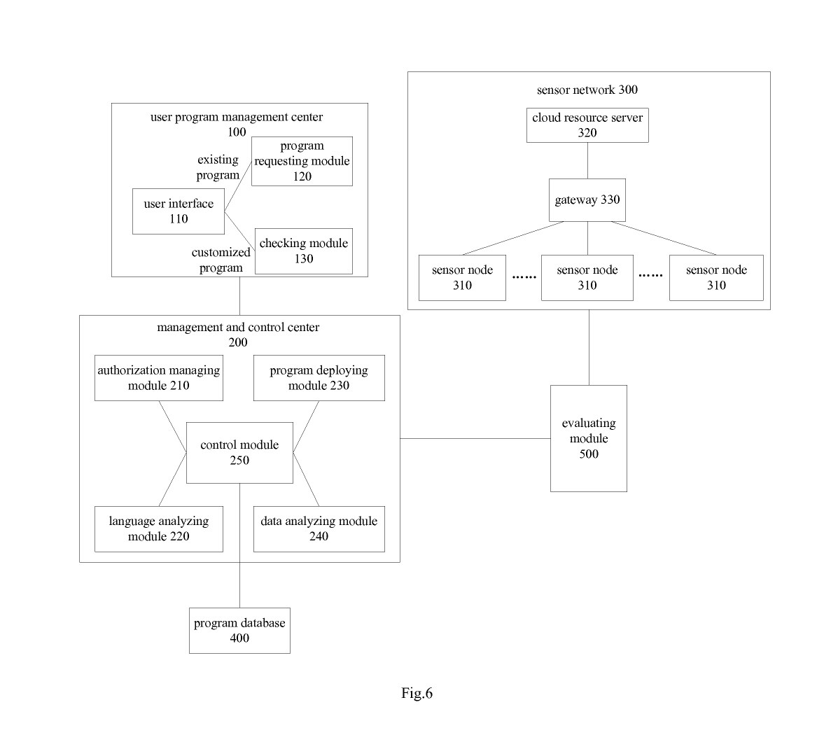

In one embodiment of the present disclosure, as shown in FIG. 6, the system further comprises a program database 400 and an evaluating module 500.

Specifically, the program database 400 is connected with the control module 250, and configured to store the existing programs, and to receive and store the customized program sent by the control module.

The evaluating module 500 is connected between the sensor network 300 and the management and control center 200. The evaluating module 500 is configured to collect the operation data of the Internet of Things, to determine whether the operation data is valid, and to send the operation data to the data analyzing module 240 when the operation data is invalid.

In one embodiment of the present disclosure, the evaluating module 500 checks whether the operation data is normal, for example, predicts an estimated operation data according to history data (or by calculating data trend) and compares the obtained operation data with the estimated operation data. If the operation data is abnormal, the corresponding sensor may lose efficiency, and the evaluating module 500 should report such information to the data analyzing module 240. Then, the data analyzing module 240 receives the operation data, obtains the operation results by analyzing the operation data and sends the operation results to the user program management center 100.

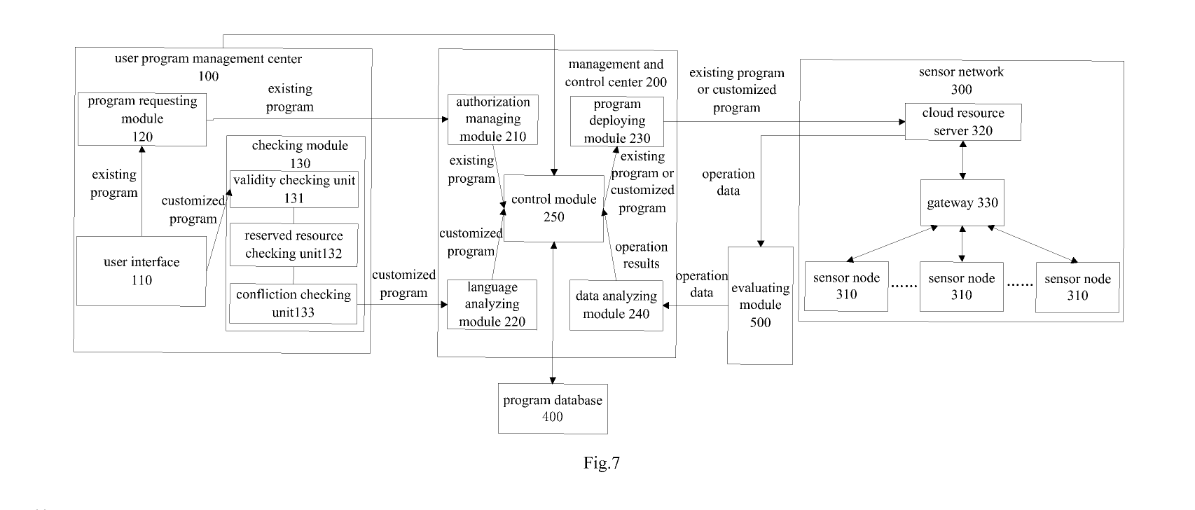

For a better understanding of the present disclosure, the overall structure and working process of the system for supporting the Internet of Things according to embodiments of the present disclosure will be described with reference to FIG. 7.

As shown in FIG. 7, users of different operators can login to the user program management center 100 and input the program identification of the existing program in the user interface 110. Then, the user interface 110 generates the request for the existing program according to the program identification and sends it to the program requesting module 120. The program requesting module 120 send the request for the existing program to the management and control center 200. The authorization managing module 210 of the management and control center 200 authorizes the request for the existing program according to the preset rules, and submits the authorized request for the existing program to the control module 250. Then, the control module 250 calls the existing program from the program database 400 according to the request for the existing program.

When the existing programs in the program database 400 cannot meet the needs of the user, the user can input the description of resource requirements and the description of functional requirements to the user interface 110 after login to the user program management center 100. Then, the user interface 110 can generate the request for the customized program according to the description of resource requirements and the description of functional requirements and send the request for the customized program to the checking module 130. The checking module 130 can perform a validity check, a reserved resource check and a confliction check to the request for the customized program. When the request for the customized program passes the validity check, the reserved resource check and the confliction check, the checking module 130 sends the request for the customized program to the language analyzing module 220. Then, the language analyzing module 220 analyzes the request for the customized program according to preset semantic and grammar rules to obtain the customized program and sends the customized program to the control module 250. The control module 250 can store the customized program in the program database 400.

Then, the control module 250 sends the existing program or the customized program to the program deploying module 230. The program deploying module 230 sends the existing program or the customized program to the cloud resource server 320. The cloud resource server 320 sends the existing program or the customized program to the corresponding sensor nodes 310 via the gateway 330. The corresponding sensor nodes 310 run the existing program or the customized program, obtain the operation data and send the operation data to the cloud resource server 320 via the gateway 330.

In this embodiment, the cloud resource server sends the operation data to the evaluating module 500. The evaluating module 500 evaluates the operation data and sends the evaluated operation data to the data analyzing module 240. Then, the data analyzing module 240 analyzes the operation data to obtain the operation results and send the operation results to the control module 250. At last the control module 250 sends the operation data to the user program management center 100, or adopts corresponding software repair according to the operation results. For example, when the operation result obtained by running program A does not meet the expectation of the user, the program A can be repaired or modified by the control module 250. It should be noted that, the request for the existing program is directly submitted to the management and control center 200 when the program requesting module receives the request for the existing program. However, the request for the customized program can be submitted to the management and control center 200 only when it passes the valid check, the reserved resource check and the confliction check performed by the checking module 130. Moreover the control module 250 stores the customized program in the program database 400. Thus, when the user needs the same operation data again, the programs stored in the program data base 400 can meet the requirements of the user, without the need of rewriting the customized program.

The control module 250 can analyze the operation data, modify, adjust, or update the existing program or the customized program, and deploy the modified, adjusted or updated existing program or customized program to the sensor network 300, thus maintaining the corresponding infrastructure network.

The system according to embodiments of the present disclosure provides a universal platform for different operators, which unifies the Internet of Things effectively, thus facilitating expanding services of the operators and providing a good environment for the Internet of Things.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions. This should be understood by those skilled in the art which embodiments of the present disclosure belong to.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in a electric manner, and then the programs may be stored in the computer memories.

It is understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A universal support system for Internet of Things, comprising:
a user program management center, configured to send a request for an existing program or a request for a customized program according to an instruction input by a user, wherein the request for the customized program comprises description of resource requirements and description of functional requirements;
a management and control center, connected with the user program management center, and configured to obtain an existing program according to the request for the existing program, to generate a customized program according to the request for the customized program, to deploy the existing program, and to deploy the customized program according to the description of resource requirements and description of functional requirements of the customized program; and
a sensor network, connected with the management and control center, and configured to run the existing program or the customized program according to a deployment of the management and control center, to obtain operation data of the Internet of Things generated during running the existing program or the customized program, and to send the operation data to the management and control center, wherein the management and control center receives the operation data and transfers the operation data to the user program management center for display.

2. The universal support system according to claim 1, wherein the user program management center comprises:
a user interface, configured to receive a program identification, the description of resource requirements and the description of functional requirements input by the user, to generate the request for the existing program according to the program identification, and to generate the request for the customized program according to the description of resource requirements and the description of functional requirements;
a program requesting module, configured to send the request for the existing program to the management and control center; and
a checking module, configured to perform a validity check, a reserved resource check and a confliction check according to pre-stored information of the sensor network, the description of resource requirements and the description of functional requirements, and to send the request for the customized program to the management and control center when the request for the customized program passes the validity check, the reserved resource check and the confliction check.

3. The universal support system according to claim 1, wherein the management and control center comprises:
an authorization managing module, configured to receive the request for the existing program, and to authorize the request for the existing program according to preset rules;
a language analyzing module, configured to receive the request for the customized program, and to generate the customized program by analyzing the request for the customized program according to preset semantic and grammar rules;
a program deploying module, configured to deploy the existing program and the customized program according to the information of the sensor network, the description of resources requirements and description of functional requirements;
a data analyzing module, configured to receive the operation data of the Internet of Things sent by the sensor network, and to obtain operation results by analyzing the operation data of the Internet of Things; and
a control module, connected with the authorization managing module, the language analyzing module, the program deploying module and the data analyzing module respectively, and configured to obtain the existing program when the request for the existing program is authorized by the authorization managing module, to send the existing program and the customized program to the program deploying module, to receive the operation results sent by the data analyzing module, and to update or modify the existing program or the customized program according to the operation results.

4. The universal support system according to claim 3, wherein the authorization managing module is further configured to authorize the request for the existing program when the user inputting the request for the existing program is a paying user.

5. The universal support system according to claim 3, wherein the management and control center further comprises:
a program database, connected with the control module, and configured to store the existing programs, and to receive and store the customized program sent by the control module.

6. The universal support system according to claim 2, wherein the sensor network comprises:
a plurality of sensor nodes, configured to run the existing program or the customized program according to the deployment of the management and control center, and to obtain the operation data of the Internet of Things generated during running the existing program or the customized program;
a cloud resource server, connected with the plurality of sensor nodes, and configured to store the information of the sensor network, to receive the existing program or the customized program, to send the existing program or the customized program to corresponding ones of the plurality of sensor nodes according to the deployment of the management and control center, to receive the operation data sent by the corresponding ones of the plurality of sensor nodes, and to send the operation data to the management and control center; and
a gateway, configured to connect the plurality of sensor nodes with the cloud resource server.

7. The universal support system according to claim 6, wherein the cloud resource server is further configured to send the information of the sensor network to the control module so as to update the information of the sensor network.

8. The universal support system according to claim 6, wherein the data analyzing module is further configured to select parameters of the operation data according to the description of functional requirements, and to obtain the operation results by analyzing the selected parameters.

9. The universal support system according to claim 7, wherein the checking module comprises:
a validity checking unit, configured to check whether the request for the customized program is valid;
a reserved resource checking unit, configured to check whether there are sensor nodes satisfying the resource requirements of the customized program according to the information of the sensor network and the description of resource requirements; and
a confliction checking unit, configured to check whether there is a confliction between the customized program and the existing programs stored in the program database according to the description of functional requirements.

10. The universal support system according to claim 6, further comprising:
an evaluating module, connected between the sensor network and the management and control center, and configured to collect the operation data of the Internet of Things, to determine whether the operation data is valid, and to send the operation data to the data analyzing module when the operation data is invalid.

11. The universal support system according to claim 2, wherein the information of the sensor network comprises a name, a type and an operation mode of each sensor node in the sensor network.
